(19) United States
(12) Patent Application Publication
(10) Pub. No.: US 2008/0288327 A1
(43) Pub. Date: Nov. 20, 2008

(54) STORE MANAGEMENT SYSTEM AND PROGRAM

(75) Inventors: Kouji WATARAI, Tokyo (JP); Tetsuya KAWAI, Tokyo (JP)

Correspondence Address: MOTS LAW, PLLC, 1001 PENNSYLVANIA AVE. N.W., SOUTH, SUITE 600, WASHINGTON, DC, 20004, US

(73) Assignee: DENTSU RETAIL MARKETING INC., Tokyo (JP)

(21) Appl. No.: 11/861,521

(22) Filed: Sep. 26, 2007

(30) Foreign Application Priority Data
May 15, 2007 (JP) JP2007-129818

(51) Int. Cl. G06Q 30/00; G06F 17/30

(52) U.S. Cl. 705/10; 235/383

(57) ABSTRACT

A store management system of the present invention includes a storage device configured to store index data for associating identification information on a product, a purchase proportion, a purchase amount per purchasing customer and a repeat purchase proportion, a customer indicator value calculating unit configured to calculate customer indicator value on the product by multiplying the purchase proportion, the purchase amount per purchasing customer and the repeat purchase proportion, and to generate customer indicator value data for associating the identification information on the product and the generated customer indicator value with each other; and a calculating unit configured to perform a predetermined calculation using the customer indicator value data.

### CROSS REFERENCE TO RELATED APPLICATIONS

This application is based upon and claims the benefit of priority from prior Japanese Patent Application No. 2007-129818, filed on May 15, 2007; the entire contents of which are incorporated herein by reference.

### BACKGROUND OF THE INVENTION

1. Field of the Invention

The present invention relates to a store management system and a program for the store management system.

2. Description of the Related Art

Currently, results (index) of ABC analysis obtained by POS (Point of Sale) data are used for a decision making for a selection of products and a store arrangement (a floor-layout management and a shelf-allocation management and the like).

Here, ABC analysis means a method in which merchandises are ranked according to net sales and gross profit from the highest to the lowest.

Specifically, in existing stores, all the decisions from the selection of products to the shelf allocation, such as expanding fast selling products, introducing new products and eliminating slow selling products, are made using the results of the above-mentioned ABC analysis.

[Non-Patent Document 1]Gekkan Merchandising (Monthly Merchandising) pp. 66-67, April 2007

However, the decisions made by using conventional ABC analysis (index) are focused only on the net sales and the gross profit at the time when the decisions are made. The decisions do not make good use of a purchase history of each customer.

Accordingly, in such decisions, there is a problem that strategic CRM (Customer Relationship Management) in which the purchase history of each customer is taken into account cannot be implemented.

Moreover, there is another problem that although a maximization of present values (present net sales and gross profit) can be aimed, a maximization of future values (future net sales and gross profit) cannot be aimed.

### BRIEF SUMMARY OF THE INVENTION

The present invention has been made in view of the above problems. An object of this invention is to provide a store management system and a program for the store management system with which strategic CRM in which a purchase history of each customer is taken into account can be implemented and a maximization of future values (future net sales and gross profit) can be aimed.

A first aspect of the present invention is summarized as a store management system. The store management system includes a storage device configured to store index data for associating identification information on a product, a purchase proportion, a purchase amount per purchasing customer and a repeat purchase proportion with each other, the purchase proportion indicating a proportion of the number of purchasing customers who purchase the product to the total number of customers who come to a predetermined store in a predetermined period, the purchase amount per purchasing customer indicating a total purchase amount of the product per purchasing customers, the repeat purchase proportion indicating a proportion of the number of the purchasing customers who purchased the product in the predetermined period to the number of the purchasing customers who purchased the product in a previous period of the predetermined period; a customer indicator value calculating unit configured to calculate a customer indicator values on the product by multiplying the purchase proportion, the purchase amount per purchasing customer and the repeat purchase proportion, and to generate customer indicator value data for associating the identification information on the product and the generated customer indicator value with each other; and a calculating unit configured to perform a predetermined calculation using the customer indicator value data.

In the first aspect of the invention, the store management system may further comprise a parameter setting unit configured to set space elasticity indicating an increasing proportion of the customer indicator value when the number of products arranged in a row is increased by one in each zone of a gondola, and the calculating unit may be configured to perform calculation, as the predetermined calculation, for determining how to arrange the products in each zone of the gondola on the basis of the space elasticity and the customer indicator value data.

In the first aspect of the invention, the customer indicator value calculating unit may be configured to generate the customer indicator value data for every customer ranked by total purchase amount of the product in the predetermined period.

A second aspect of the present invention is summarized as a program for causing a computer to execute a store management function, wherein the store management function comprise; a storage unit configured to store, in a storage device integrated in the computer, index data for associating identification information on a product, a purchase proportion, a purchase amount per purchasing customer and a repeat purchase proportion with each other, the purchase proportion indicating a proportion of the number of purchasing customers who purchased the product to the total number of customers who come to a predetermined store in a predetermined period, the purchase amount per purchasing customer indicating a total purchase amount of the product per purchasing customers, the repeat purchase proportion indicating a proportion of the number of the purchasing customers who purchased the product in the predetermined period to the number of the purchasing customers who purchased the product in a previous period of the predetermined period; a customer indicator value calculating unit configured to extract the index data from the storage device, to calculate a customer indicator value on the product by multiplying the purchase proportion, the purchase amount per purchasing customer and the repeat purchase proportion, and to generate customer indicator value data for associating the identification information on the product and the generated customer indicator value with each other; and a calculating unit configured to perform a predetermined calculation using the customer indicator value data, and to transmit results of the predetermined calculation to a display device or an output device integrated in the computer.

In the second aspect of the invention, the store management function may further comprise a parameter setting unit configured to set space elasticity indicating an increasing proportion of the customer indicator value when the number of products arranged in a row is increased by one in each zone of a gondola, and the calculating unit configured to perform calculation, as the predetermined calculation, for determining how to arrange the products in each zone of the gondola on the basis of the space elasticity and the customer indicator value data.

In the second aspect of the present invention, the customer indicator value calculating unit may be configured to generate the customer indicator value data for every customer ranked by total purchase amount of the product in the predetermined period.

### BRIEF DESCRIPTION OF THE SEVERAL VIEWS OF THE DRAWINGS

FIG. 1 is a block diagram showing a hardware configuration of a store management system according to a first embodiment of the present invention.

FIG. 2 is a block diagram showing a function of the store management system according to the first embodiment of the present invention.

FIG. 3 is a drawing showing an example of customer data to be stored in a storage device of the store management system according to the first embodiment of the present invention.

FIG. 4 is a drawing showing an example of index data to be stored in the storage device of the store management system according to the first embodiment of the present invention.

FIG. 5 is a drawing showing an example of CVI value data to be stored in the storage device of the store management system according to the first embodiment of the present invention.

FIG. 6 is a diagram showing an example of parameters to be stored in the storage device of the store management system according to the first embodiment of the present invention.

FIG. 7 is a drawing for explaining shelf allocation in the store management system according to the first embodiment of the present invention.

FIG. 8 is a flowchart showing a procedure of the store management system according to the first embodiment of the present invention.

### DETAILED DESCRIPTION OF THE INVENTION

### (A Store Management System According to a First Embodiment of the Present Invention)

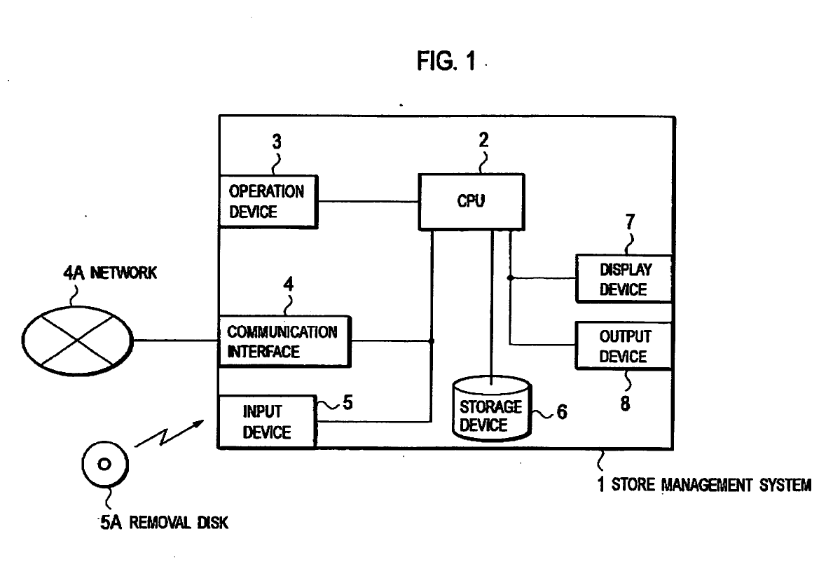

A configuration of a store management system 1 according to a first embodiment of the present invention will be described with reference to the drawings from FIGS. 1 to 7.

The store management system 1 according to this embodiment achieves strategic CRM in which a purchase history of each customer is taken into account. The store management system 1 also achieves a selection of products and the store arrangement which are optimal for each store by aiming a maximization of future values (future net sales and gross profit).

Hardware of the store management system 1 according to this embodiment will be described with reference to FIG. 1.

As shown in FIG. 1, the store management system according to this embodiment includes, as a hardware configuration, a CPU 2, an operation device 3, a communication interface 4, an input device 5, a storage device 6, a display device 7 and an output device 8.

Hereinafter, since the hardware configuration of the store management system 1 is similar to that of a general computer system, the hardware configuration only for this invention will be described.

The CPU 2 is configured to obtain function (store management function) of the store management system 1 by carrying out a predetermined program stored in the storage device 6.

The operation device 3 is configured to transmit, to the CPU 2, an operation instruction corresponding to a predetermined operation performed by a user.

The communication interface 4 is configured to perform communications among individual stores through networks such as the Internet, a dedicated network, or the like. For example, the communication interface 4 is configured to exchange customer data (POS data) among the individual stores. In this embodiment, the customer data means the POS data including the purchase history of each customer.

The input device 5 is configured to obtain predetermined data (for example, customer data) through removal media such as a CD-ROM.

The storage device 6 consists of a RAM (Random Access Memory), a ROM (Read Only Memory), a hard disk, or the like.

The display device 7 is configured to show predetermined images (static images or dynamic images) on the display according to the instruction from the CPU 2.

The output device 8 is configured to output predetermined data to a predetermined device (for example, a printer) or removal media (for example, a CD-ROM) in a predetermined format according to the instruction from the CPU 2.

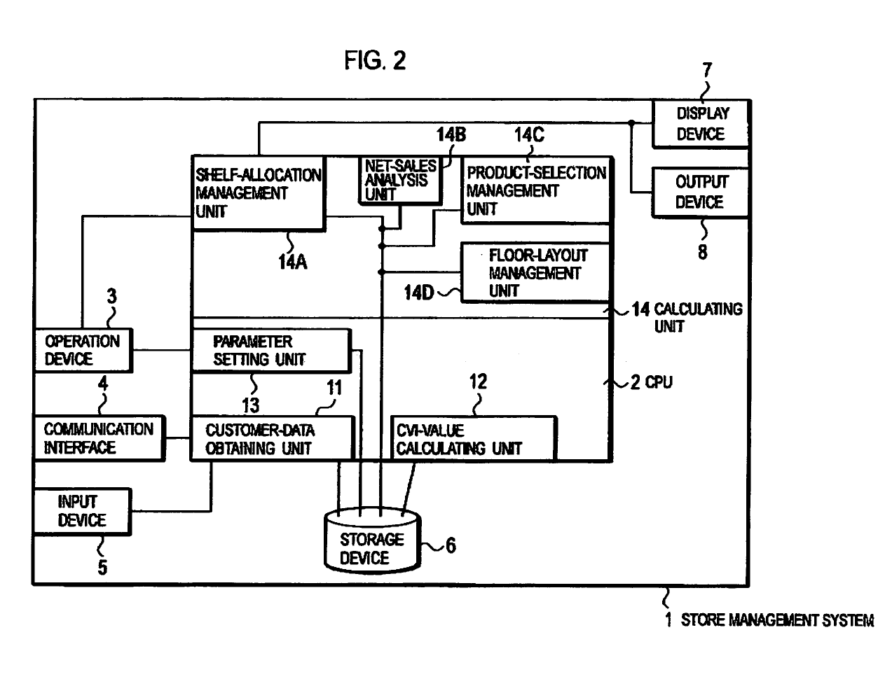

As shown in FIG. 2, the function (store management function) of the store management system 1 can be operated when the CPU 2 carries out a predetermined program. The store management system 1 includes a customer data obtaining unit 11, a CVI value calculating unit 12, a parameter setting unit 13, and a calculating unit 14.

The customer data obtaining unit 11 is configured to obtain customer data through the communication interface 4 or the input device 5, and to store the obtained customer data to the storage device 6.

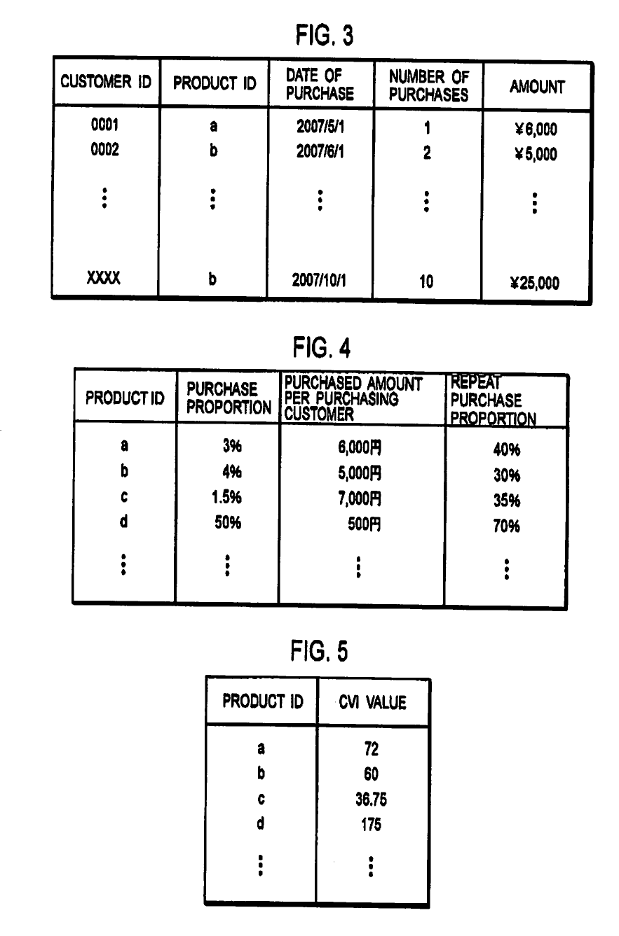

For example, the customer data obtaining unit 11 may be configured to obtain the customer data shown in FIG. 3. The customer data indicates the purchase history of individual customers in each store obtained by the POS terminals.

In the customer data shown in FIG. 3 “Customer ID”, “Product ID”, “Date of Purchase”, “Number of Purchases” and “Amount” are associated with each other.

Here, the “Customer ID” indicates customer identification information; the “Product ID” indicates products (target products) identification information; the “Date of Purchase” indicates the date which the products were purchased by the customer; the “Number of Purchases” indicates the number of products the customer purchased; and the “Amount” indicates the amount of the products which were purchased by the customer.

In addition, the customer data obtaining unit 11 is configured to generate index data shown in FIG. 4 according to the customer data shown in FIG. 3 and to store the generated index data to the storage device 6.

The index data shown in FIG. 4 is the data for associating the “Product ID”, the “Purchase Proportion”, the “Purchase Amount Per Purchasing Customer” and the “Repeat Purchase Proportion” with each other.

Here, the “Purchase Proportion” indicates a proportion of the number of purchasing customers (simply referred to as purchasing customers) who purchase the product to the total number of customers who come to a predetermined store in a predetermined period. Specifically, the “Purchase Proportion” is an index to show how many percent of customers who come to the predetermined store in the predetermined period purchased the products.

Moreover, the “Purchase Amount Per Purchasing Customer” indicates a total purchase amount of the product per purchasing customers. In other words, the “Purchased Amount Per Purchasing Customer” is an index to show how much in average the purchasing customer spent to purchase the product in the predetermined store in the predetermined period of time.

Furthermore, the “Repeat Purchase Proportion (Repeat Ratio)” indicates a proportion of the number of the purchasing customers who purchased the product in the predetermined period to the number of the purchasing customers who purchased the product in a previous period of the predetermined period. In other words, the “repeat Purchase Proportion” is an index to estimate how many percent of purchasing customers, among the purchasing customers who purchased the products in the predetermined period in the predetermined store, would purchase the products the next period after the predetermined period in the predetermined store.

Note that, the customer data obtaining unit 11 may be configured to obtain the index data instead of the above-mentioned customer data through the communication interface 4 or the input device 5.

The CVI value calculating unit 12 is configured to calculate customer indicator value (CVI value) on the product, to generate customer indicator value data (CVI value data), and to store the data to the storage device 6. The CVI value is generated by multiplying the above-mentioned “Purchase Proportion”, “Purchase Amount Per Purchasing Customer” and “Repeat Purchase Proportion”. The CVI value data is generated for the purpose of associating identification information on a product to the generated CVI value.

Accordingly, net sales and gross profit for each product after the predetermined period can be estimated by using the CVI values.

In this embodiment, as shown in FIG. 5, the CVI value calculating unit 12 calculates the CVI value for the product a as follows:

(Purchase Proportion of 3%)×(Purchase Amount Per Purchasing Customer of 6000 yen)×(Repeat Purchase Proportion of 40%)=72

Moreover, the CVI value calculating unit 12 calculates the CVI value for the product b as follows:

(Purchase Proportion of 4%)×(Purchase Amount Per Purchasing Customer of 5000 yen)×(Repeat Purchase Proportion of 30%)=60

Furthermore, the CVI value calculating unit 12 calculates the CVI value for the product c as follows:

(Purchase Proportion of 1.5%)×(Purchase Amount Per Purchasing Customer of 7000 yen)×(Repeat Purchase Proportion of 35%)=36.75

In addition, the CVI value calculating unit 12 calculates the CVI value for the product d as follows:

(Purchase Proportion of 50%)×(Purchase Amount Per Purchasing Customer of 500 yen)×(Repeat Purchase Proportion of 70%)=175

The parameter setting unit 13 is configured to set predetermined parameters according to an operation instruction received from a user through the operation device 3.

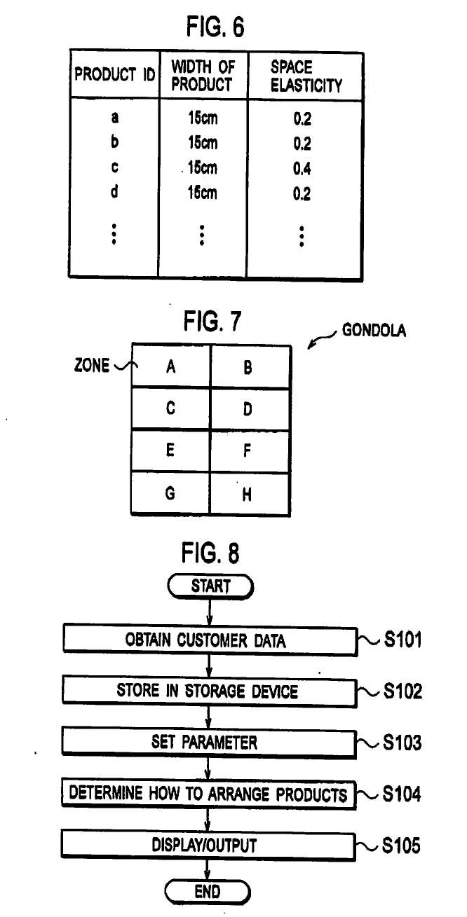

For example, the parameter setting unit 1a, as shown in FIG. 6, is configured to set parameters for associating “Product ID”, “Width of Product” and “Space Elasticity” with each other.

The “Width of Product” indicates the width of a product and the “Space Elasticity” indicates an increasing proportion of the CVI values when the number of products arranged in a row is increased by one in each zone of a gondola.

The calculating unit 14 is configured to perform predetermined calculations (calculations related to the CRM) using the CVI value data. Specifically, the calculating unit 14 is configured to perform the above-mentioned predetermined calculation using components of a shelf-allocation management unit 14A, a net-sales analysis unit 14B, a product-selection management unit 14C and a floor-layout management unit 14D.

The shelf-allocation management unit 14A is configured to perform calculation for determining how to arrange the products in each zone of the gondola shown in FIG. 7. The calculation is performed, as the predetermined calculation mentioned above, on the basis of the “Space Elasticity” set as a parameter and the above-mentioned CVI value data.

Specifically, the shelf-allocation management unit 14A determines how to arrange the products to maximize the CVI value for each zone.

In the examples in FIGS. 5 to 7, five products can be arranged in a zone A. Although the shelf-allocation management unit 14A presuppose arranging two products from products a to d.

Here, when two of product a are arranged, the CVI value is calculated as follows:

{72×1.2 product a)}+{60 (product b)}+{36.75 (product c)}+{175 (product d)}=(358.15)

When two of product b are arranged, the CVI value is calculated as follows:

{72 (product a)}+{60×1.2 (product b)}+{36.75 (product c)}+{175 (product d)}=(355.75)

When two of product c are arranged, the CVI value is calculated as follows:

{72 (product a)}+{60 (product b)}+{36.75×1.2 (product c)}+{175 (product d)}=(344.95)

When two of product dare arranged, the CVI value is calculated as follows:

{72 (product a)}+{60 (product b)}+{36.75 (product c)}+{175×1.2 (product d)}=(378.75)

Accordingly, the shelf-allocation management unit 14A determines to arrange two of product din the zone A.

The net-sales analysis unit 14B is configured to perform, as the predetermined calculation mentioned above, a net-sales analysis processing with an arbitrary method using the above-mentioned CVI value data.

For example, the net-sales analysis unit 14B may be configured to transmit a ranking result, to the display device 7 or the output device 8, obtained by ranking each product according to the above-mentioned CVI values from the highest to the lowest.

The product-selection management unit 14C is configured to perform, as the predetermined calculation mentioned above, a product-selection management processing with an arbitrary method using the above-mentioned CVI value data.

The floor-layout management unit 14D is configured to perform, as the predetermined calculation mentioned above, a floor-layout management processing with an arbitrary method using the above-mentioned CVI value data.

### (Procedure of the Store Management System According to the First Embodiment of the Present Invention)

Hereinafter, a procedure of the store management system according to the embodiment will be described with reference to FIG. 8.

As shown in FIG. 8, the customer data obtaining unit 11 obtains the customer data through the communication interface 4 or the input device 5 in Step S101, and calculates the index data from the obtained customer data and stores the index data to the storage device 6 in Step S102.

In Step S103, the parameter setting unit 13 sets a predetermined parameter (for example, a parameter shown in FIG. 6) in the storage device 6 according to the operation instruction from the user through the operation device 3.

In Step S104, the shelf-allocation management unit 14A in the calculating unit 14 determines how to arrange each product to maximize the CVI values in each zone of the gondola according to the operational instruction from the user through the operation device 3.

In Step S105, the product-arrangement way thus determined by the shelf-allocation management unit 14A in the calculating unit 14 is shown on the display by using the display device 7, or is outputted to a predetermined device through the output device 8.

### (Advantageous Effects of the Store Management System According to the First Embodiment of the Present Invention)

According to the store management system of the embodiment, decisions from the selection of products to the shelf allocation can be made by calculating CVI (Customer Value Indicator) values which can be obtained by multiplying the “Purchase Proportion”, the “purchase Amount Per Purchasing Customer” and the “Repeat Purchase Proportion.” Consequently, the strategic CRM in which the purchase history of each customer is taken into account can be implemented and the future values (future net sales and gross profits) can be maximized.

According to the store management system of the embodiment, product-arrangement ways (shelf allocation) which maximize the CVI values at an arbitrary point of time in the future can be calculated.

According to the store management system of the embodiment, the strategic CRM to achieve keeping and cultivating the most profitable customers falling under the category of best customers can be implemented.

### MODIFIED EXAMPLE 1

According to the store management system 1 in a modified example 1, the CVI value calculating unit 12 is configured to generate the CVI value data for every customer ranked by the total purchase amount of the product in a predetermined period.

According to the store management system 1 in the modified example 1, the calculating unit 14 performs predetermined calculations (calculations related to CRM) using the CVI value data of “best customers” whose total purchase amount of the product is more than a certain purchase amount of the product in a predetermined period. Consequently, the CRM in which the purchase history of “best customers” is preferentially taken into account can be implemented.

### MODIFIED EXAMPLE 2

Meanwhile, the store management system 1 in a modified example 2, the system may be configured to use the index data including the “Number of Customers Purchased” instead of the above-mentioned “Purchase Proportion.”

What is claimed is:

1. A store management system, comprising:
a storage device configured to store index data for associating identification information on a product, a purchase proportion, a purchase amount per purchasing customer and a repeat purchase proportion with each other, the purchase proportion indicating a proportion of the number of purchasing customers who purchase the product to the total number of customers who come to a predetermined store in a predetermined period, the purchase amount per purchasing customer indicating a total purchase amount of the product per purchasing customers, the repeat purchase proportion indicating a proportion of the number of the purchasing customers who purchased the product in the predetermined period to the number of the purchasing customers who purchased the product in a previous period of the predetermined period;
a customer indicator value calculating unit configured to calculate a customer indicator value on the product by multiplying the purchase proportion, the purchase amount per purchasing customer and the repeat purchase proportion, and to generate customer indicator value data for associating the identification information on the product and the generated customer indicator value with each other; and
a calculating unit configured to perform a predetermined calculation using the customer indicator value data.

2. The store management system according to claim 1, further comprising:
a parameter setting unit configured to set space elasticity indicating an increasing proportion of the customer indicator value when the number of products arranged in a row is increased by one in each zone of a gondola,
wherein the calculating unit is configured to perform calculation, as the predetermined calculation, for determining how to arrange the products in each zone of the gondola on the basis of the space elasticity and the customer indicator value data.

3. The store management system according to claim 1, wherein, the customer indicator value calculating unit is configured to generate the customer indicator value data for every customer ranked by total purchase amount of the product in the predetermined period.

4. A program for causing a computer to execute a store management function, wherein the store management function comprise:
a storage unit configured to store, in a storage device integrated in the computer, index data for associating identification information on a product, a purchase proportion, a purchase amount per purchasing customer and a repeat purchase proportion with each other, the purchase proportion indicating a proportion of the number of purchasing customers who purchased the product to the total number of customers who come to a predetermined store in a predetermined period, the purchase amount per purchasing customer indicating a total purchase amount of the product per purchasing customers, the repeat purchase proportion indicating a proportion of the number of the purchasing customers who purchased the product in the predetermined period to the number of the purchasing customers who purchased the product in a previous period of the predetermined period;
a customer indicator value calculating unit configured to extract the index data from the storage device, to calculate a customer indicator value on the product by multiplying the purchase proportion, the purchase amount per purchasing customer and the repeat purchase proportion, and to generate customer indicator value data for associating the identification information on the product and the generated customer indicator value with each other; and
a calculating unit configured to perform a predetermined calculation using the customer indicator value data, and to transmit results of the predetermined calculation to a display device or an output device integrated in the computer.

5. The program according to claim 4,
wherein the store management function include a parameter setting unit configured to set space elasticity indicating an increasing proportion of the customer indicator value when the number of products arranged in a row is increased by one in each zone of a gondola, and
the calculating unit configured to perform calculation, as the predetermined calculation, for determining how to arrange the products in each zone of the gondola on the basis of the space elasticity and the customer indicator value data.

6. The program according to claim 4,
wherein the customer indicator value calculating unit is configured to generate the customer indicator value data for every customer ranked by total purchase amount of the product in the predetermined period.
